(19) United States
(12) Patent Application Publication
(10) Pub. No.: US 2019/0040789 A1
(43) Pub. Date: Feb. 7, 2019

(54) VARIABLE-COMPRESSION RATIO INTERNAL-COMBUSTION ENGINE WITH TWO MIXING ZONES, NOTABLY FOR A MOTOR VEHICLE, AND METHOD OF INJECTION FOR SUCH A VEHICULE

(71) Applicant: IFP Energies nouvelles, Rueil-Malmaison Cedex (FR)

(72) Inventors: Gaetano DE PAOLA, PARIS (FR); Jean-Marc ZACCARDI, LYON (FR); Philippe DEGEILH, PARIS (FR); Stephane CHEVILLARD, NANTERRE (FR)

(21) Appl. No.: 16/072,905

(22) PCT Filed: Jan. 9, 2017
(86) PCT No.: PCT/EP2017/050328

§ 371 Date: Jul. 26, 2018

(30) Foreign Application Priority Data
Jan. 26, 2016 (FR) 16 50592

(51) Int. Cl. F02B 23/06; F02B 75/04

(52) U.S. Cl. CPC F02B 23/0693; F02B 75/04; F02B 23/0669; F02B 23/0651

(57) ABSTRACT

A variable-compression ratio direct-injection internal-combustion engine comprising at least a cylinder (10), a cylinder head (12) carrying a fuel injection means (14) spraying fuel in a single sheet (34) of fuel jets (36), a piston (16) sliding in this cylinder, and a combustion chamber (32) delimited on one side by upper face (42) of the piston comprising a projection (46) rising up towards the cylinder head and arranged in the cent of a concave bowl (44). According to the invention, the combustion chamber comprises at least two mixing zones (Z1, Z2) into which fuel jets (36) are injected, one (Z1) of the zones being used for a maximum compression ratio (Tmax) and the other (Z2) zone being used for a minimum compression ratio (Tmini).

Reference is made to PCT/EP2017/050328 filed Jan. 9, 2017, and French Application No. 16/50.592 filed Jan. 26, 2016, which are incorporated herein by reference in their entirety.

### BACKGROUND OF THE INVENTION

### Field of the Invention

The present invention relates to a variable-compression ratio direct-injection internal-combustion engine, notably for a motor vehicle, and to an injection method for such an engine.

### Description of the Prior Art

Combustion systems for internal-combustion engines have to meet demands relative to reduction of pollution emissions, torque and specific power increase, as well as combustion noise reduction, while remaining compatibility with endurance tolerance criteria.

To meet this demand, it is possible to modify the compression ratio of the combustion engine according to the power demand.

As it is generally known, the compression ratio of an engine is the ratio of the volume of the combustion chamber when the piston is in bottom dead center position to the volume of the chamber when the piston is in top dead center position, which is referred to as the “dead volume”.

Many devices allow the spatial position of the piston in the cylinder to be modified.

More particularly, some of these devices make possible changing the compression ratio of the engine by modifying the dead volume of the combustion chamber when the piston is at top dead center. The final position of the piston with respect to the cylinder head just needs to be modified when it is at top dead center.

Thus, for a minimum compression ratio (maximum dead volume), the distance between the top of the piston and the cylinder head is greater than that relative to a maximum compression ratio (minimum dead volume).

However, such engines with variable compression ratios (VCR) have significant drawbacks.

Indeed, as better described in French patent application FR-2,891,867, this type of engine generally comprises a cylinder, a piston comprising a projection arranged in a concave bowl and sliding in this cylinder in a reciprocating rectilinear motion, intake means for an oxidizer, burnt gas exhaust, means for varying the position of the piston top dead center and fuel injection for injecting a fuel into the combustion chamber of this engine.

As detailed in this prior art document, the fuel injection comprises an injector with two superposed rows of injection orifices allowing the fuel to be injected as one or two superposed fuel jet sheets.

Thus, for a high compression ratio, the fuel is injected in a single sheet of jets and, for a low compression ratio, the fuel is injected with two sheet angles.

This type of engine therefore requires a multi-fuel sheet injector of complex design, which is necessarily associated with a sophisticated control device for operation of at least one fuel jet sheet.

Furthermore, this type of engine with a variable compression ratio through variation of the piston/cylinder head distance has a major geometric drawback.

Indeed, by modifying the piston/cylinder head distance, the relative positioning of the injector and of the fuel jets is modified with respect to the piston bowl.

The distribution of the fuel in the chamber and the entire combustion process are therefore profoundly modified since a bowl is generally optimized only for “fixed” geometric conditions, that is a fixed position of the piston at top dead center.

Thus, in order to optimize such a variable-compression ratio engine, it is necessary to redefine a piston bowl shape that can be totally insensitive to the relative position of the injector, or at least efficient whatever the position of the injector.

The present invention overcomes these drawbacks with an engine that comprises a conventional injector with a single fuel jet sheet injecting the fuel into mixing and combustion zones of the combustion chamber, regardless of the compression ratio used for the engine.

### SUMMARY OF THE INVENTION

The invention therefore relates to a variable-compression ratio direct-injection internal-combustion engine comprising at least a cylinder, a cylinder head carrying a fuel injection means spraying fuel in a single sheet of fuel jets, a piston sliding in this cylinder, and a combustion chamber delimited on one side by the upper face of the piston comprising a projection rising up towards the cylinder head and arranged in the center of a concave bowl. The combustion chamber comprises at least two mixing zones into which the fuel jets are injected with one of the zones being used for a maximum compression ratio and the other zone being used for a minimum compression ratio.

One of the zones can be associated with the other zone for the minimum compression ratio.

The mixing zones can be axially arranged one above the other.

The mixing zones can be delimited from one another by a radial projection.

One of the mixing zones can comprise a concave surface connected to a convex surface forming the lower part of a toric volume.

The other mixing zone can comprise a concave surface connected to a convex surface forming a barrier.

The engine can comprise a piston with a bowl of bowl diameter BD, neck diameter GD, lower inflection diameter ID1, upper inflection diameter ID2, projection height H, bowl height L, height L1 of inflection diameter ID1, angle of inclination a3, radius R for the concave rounded surface of the torus and radius R2 for the concave rounded surface, and the bowl dimensions can meet at least one of the following conditions:
ratio BD/L substantially ranges between 1.3 and 1.8,
radio GD/BD substantially ranges between 0.9 and 0.95 for the torus aerodynamics and the fuel jet upflow,
ratio H/L is substantially less than 0.6 and substantially greater than 0.5 to minimize the oxidizer volume between the injector nozzle and the projection,
ratio L/L1 substantially ranges between 1.15 and 1.7,
ratio R2/R substantially ranges between 0.25 and 1,
ratio GD/ID substantially ranges between 0.65 and 0.9,
a3 substantially ranges between 50° and 70°,
bowl diameter BD is smaller than diameter ID2.

The invention also relates to a fuel injection method for a variable-compression ratio direct-injection internal-combustion engine comprising at least a cylinder, a cylinder head carrying fuel injection spraying fuel in a single sheet of fuel jets, a piston sliding in the cylinder, and a combustion chamber delimited on one side by the upper face of the piston comprising a projection rising up towards the cylinder head and arranged in the center of a concave bowl. For a maximum compression ratio, the fuel is injected into a mixing zone of the combustion chamber and, for a minimum compression ratio, the fuel is injected into another mixing zone of the combustion chamber.

For the minimum compression ratio, the fuel can be injected into both mixing zones.

### BRIEF DESCRIPTION OF THE FIGURES

Other features and advantages of the invention will be clear from reading the description hereafter, given by way of non-limitative example, with reference to the accompanying figures wherein:

FIG. 1 shows a variable-compression ratio internal-combustion engine according to the invention, in a configuration for one compression ratio,

FIG. 2 is another view of the engine of FIG. 1 for another compression ratio, and

FIG. 3 is a large-scale partial local view of the profile of the bowl of FIGS. 1 and 2.

### DETAILED DESCRIPTION OF THE INVENTION

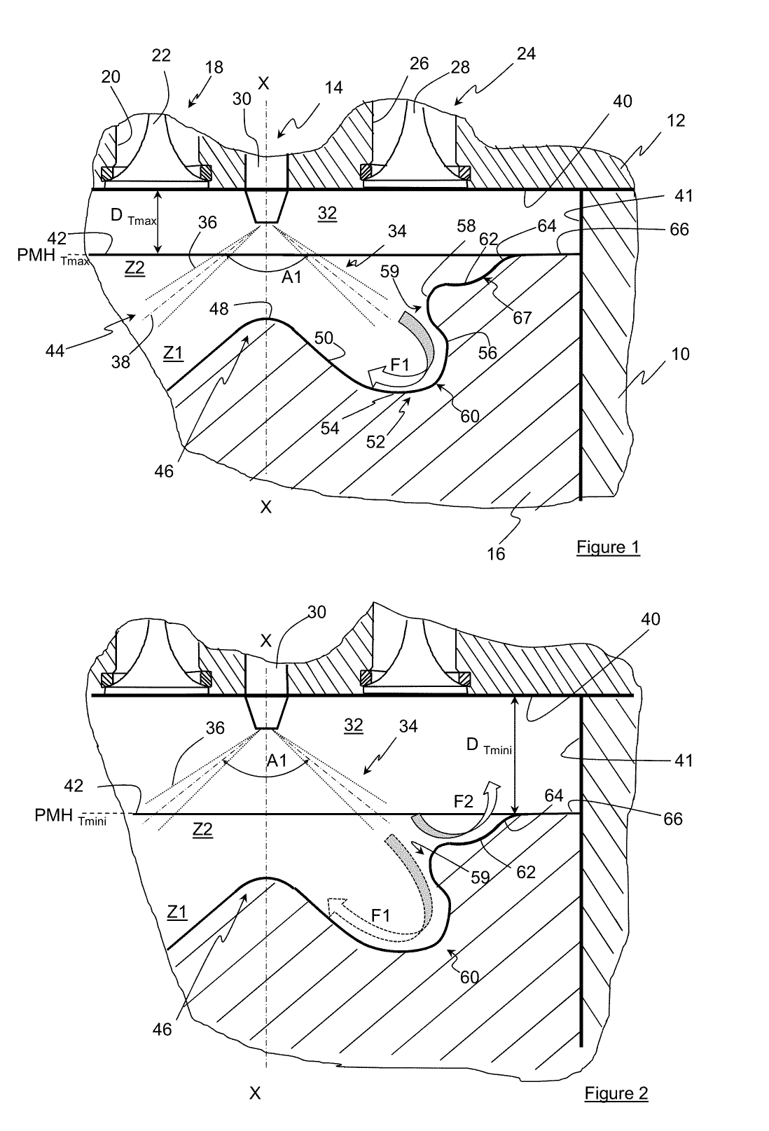

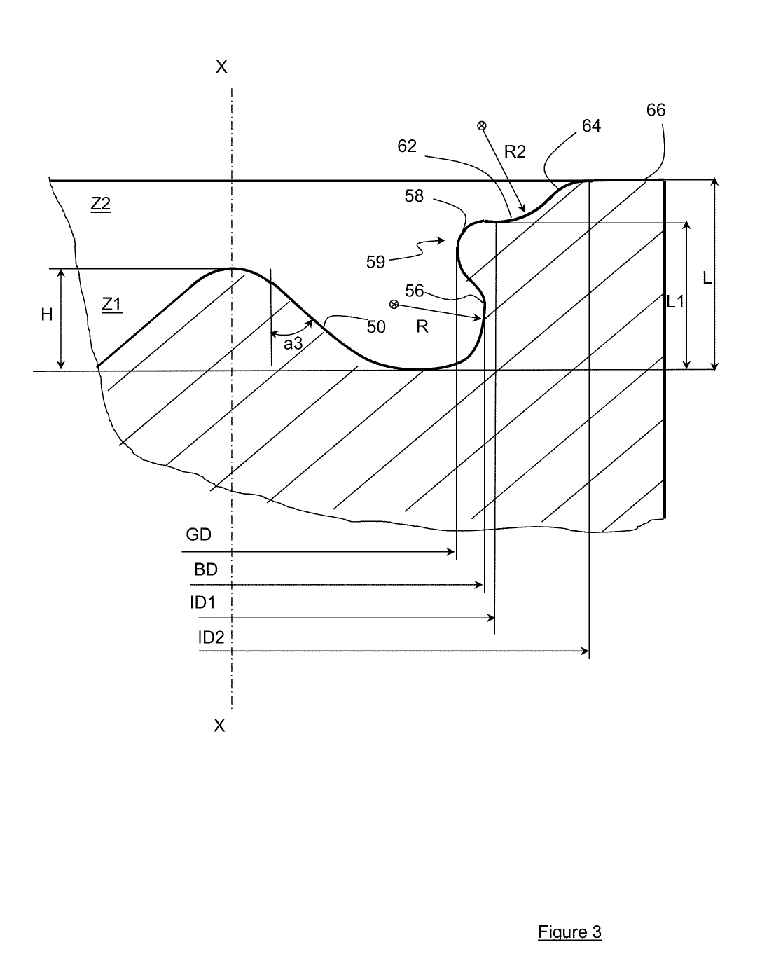

FIGS. 1 and 2 illustrate by way of non-limitative example an internal-combustion engine with variable compression ratio and direct fuel injection.

This engine is advantageously a compression-ignition engine using a diesel type fuel.

Of course, any other fuel with physico-chemical characteristics allowing operation of an engine of compression ignition type including a direct injection system can be used, such as kerosene.

This engine comprises at least a cylinder 10, a cylinder head 12 closing the cylinder in the upper part, fuel injection 14 carried by the cylinder head and a piston 16 of axis XX sliding in the cylinder with a reciprocating rectilinear motion.

This engine also comprises a burnt gas exhaust means 18 with at least one exhaust pipe 20 whose opening can be controlled in any way such as by an exhaust valve 22 for example, and an intake 24 for an oxidizer with at least one intake pipe 26 whose opening can be controlled in any way such as by an intake valve 28 for example.

An oxidizer is understood to be air at ambient pressure or supercharged air, or a mixture of air (supercharged or not) and burnt gas.

The fuel injection comprises a fuel injector 30, preferably arranged along axis XX of the piston, whose nozzle comprises a multiplicity of orifices through which the fuel is sprayed and projected in the direction of combustion chamber 32 of the engine.

It is from this injector that the projected fuel forms a single sheet 34 of fuel jets 36 of sheet angle A1 whose general axis is merged, in the example shown, with that of the piston XX.

A sheet angle is understood to be the top angle formed by the jet cone originating from the injector, whose imaginary peripheral wall passes through all the axes 38 of fuel jets 36.

Combustion chamber 32 is delimited by the inner face of cylinder head 40 opposite the piston, the circular inner wall 41 of cylinder 10, and upper face 42 of piston 16.

This upper face of the piston comprises a concave bowl 44, having an axis merged with that of the cylinder and concavity directed toward the cylinder head and which houses a projection 46 arranged substantially in the center of the bowl, which rises towards cylinder head 12, which is preferably coaxial with the axis of the fuel jet sheet.

As better illustrated in the figures, projection 46 is generally of truncated shape and comprises a preferably rounded top 48 which extends, while moving symmetrically downward away from axis XX towards the outside of the piston, by a substantially rectilinear inclined surface 50 down to a bottom 52 of the bowl.

In the example of the figures, the bottom of the bowl is rounded, with a concave rounded surface 54 in form of an arc of a circle, which is referred to as inner rounded surface, connected to the bottom of the inclined flank and another concave rounded surface 56 in form of an arc of a circle, which is referred to as outer rounded surface, connected at one end to the lower end of the inner rounded surface and at the other end thereof to a lateral wall 58, which is here substantially rounded in the direction of axis XX, to form a radial projection 59 towards the projection.

The two rounded surfaces 54 and 56 thus delimit the lower part of a toric volume 60 (or torus) delimited in the upper part by projection 59.

Rounded lateral wall 58 extends, while moving away from axis XX, as a concave rounded surface 62 that is extended by an outer convex surface 64 leading to a plane surface 66 extending up to a vicinity of wall 41 of the cylinder. Surfaces 62 and 64 form a barrier 67 whose purpose is explained in the description below.

The combustion chamber thus comprises two distinct zones Z1 and Z2 providing mixing of the oxidizer therein (air, supercharged or not, or mixture of air and recirculated burnt gas) with the fuel coming from the injector, as well as combustion of the fuel mixture formed when the physico-chemical conditions are met to provide such a combustion.

Zone Z1, delimited by projection 46, torus 60 in the bowl bottom and radial projection 59, form the lower zone of the combustion chamber. Zone Z2, delimited from projection 59 by concave surface 62, convex surface 64, plane surface 66, the peripheral inner wall of the cylinder and inner face 40 of cylinder head 12, form the upper zone of this chamber arranged above the lower zone.

As mentioned above, the engine of FIGS. 1 and 2 is a variable-compression ratio engine whose compression ratio change occurs by modifying the dead volume of the combustion chamber at piston top dead center by changing the final position of the piston with respect to the cylinder head.

Many devices, which are known to persons skilled in the art allow this result to be obtained, which include an eccentric positioned between the crank pin and the crank head, as described in French patent No. 2,801,932.

Thus, for a maximum compression ratio Tmax with a minimum dead volume (FIG. 1), the piston is at top dead center (PMH_{Tmax}) with a distance D_{Tmax} between the top of the piston and face 40 of the cylinder head. For a minimum compression ratio Tmini with a maximum dead volume (FIG. 2), the piston is at top dead center (PMH_{Tmini}), with a distance D_{Tmini} between the top of the piston and face 40 of the cylinder head that is greater than D_{Tmax}.

This engine is associated with a processor (not shown), referred to as engine calculator or processor, containing engine operating maps according to various parameters, such as the speed or the load of this engine, to determine the suitable compression ratio, and fuel injection management according to the operation of compression ratio of the engine.

In case of engine operation with a maximum compression ratio (FIG. 1), the calculator controls the compression ratio variation device so that the piston is at PMH_{Tmax}.

For this position of the piston, the calculator controls the fuel injection parameters in such a way that fuel jets 36 are sent to mixing zone Z1 of the combustion chamber.

With this parametrization, the fuel jets of sheet 34 directly target torus 60 by following the path shown by arrow F1 for better air/fuel mixing, thus allowing achieving nearly complete combustion in this torus.

Furthermore, due to the presence of radial projection 59, the fuel cannot flow into the upper part of the piston and combustion essentially takes place in zone Z1.

For a minimum compression ratio (FIG. 2), the calculator controls the compression ratio variation device so that the piston is at PMH_{Tmini} (FIG. 2).

For this position of the piston, the calculator controls the fuel injection parameters to control the delivery of fuel jets 36 into mixing zone Z2 of the combustion chamber in such a way that they impact concave surface 62 and follow the path shown by arrow F2.

Combustion thus occurs in the upper part of the combustion chamber and surfaces 62 and 64 form a barrier that prevents the fuel from being dispersed towards inner wall 41 of the cylinder. This allows limiting the transfer of carbonaceous material resulting from the combustion to the oil covering wall 41.

Preferably, for the minimum compression ratio, this injection can be carried out so that the fuel jets impact the outer edge of projection 59 closest to the projection. The fuel jets thereafter divide into two fuel streams with one of the streams being fed to zone Z1 and the other stream being fed to zone Z2, as illustrated by arrows F1 and F2 in FIG. 2, for the combustion to take place in these two zones.

FIG. 3 illustrates, on a larger scale and by way of non-limitative example, a part of the profile of the bowl described above.

In this configuration, the bowl comprises:
a bowl opening diameter BD with a radius considered in the vicinity of the bowl bottom and corresponding to a distance taken between axis XX and the furthest point of concave surface 56 in relation to this axis,
a neck diameter GD with a radius corresponding to the distance between axis XX and the end of radial projection 59 closest to the projection and thus delimiting the outlet section of zone Z1 of this bowl,
a lower inflection diameter ID1 with a radius corresponding to the distance between axis XX and the inflection point between wall 58 of projection 59 and concave surface 62,
an upper inflection diameter ID2 with a radius corresponding to the distance between axis XX and the inflection point between convex surface 64 and plane surface 66,
a projection height H between the bowl bottom and the top of the pip 46,
a bowl height L between the bowl bottom and plane surface 66,
a height L1 for diameter ID1 considered between the inflection point between wall 58 of projection 59 and concave surface 62 and the bowl bottom,
an angle of inclination a3 of inclined surface 50 of the projection with respect to a vertical,
a radius R for concave rounded surface 56 of torus 60, and
a radius R2 for concave rounded surface 62.

The dimensions of the bowl can meet at least one of the following conditions:
ratio BD/L substantially ranges between 1.3 and 1.8,
radio GD/BD substantially ranges between 0.9 and 0.95 for the torus aerodynamics and the fuel jet upflow,
ratio H/L is substantially less than 0.6 and substantially greater than 0.5 to minimize the oxidizer volume between the injector nozzle and the projection,
ratio L/L1 substantially ranges between 1.15 and 1.7,
ratio R2/R substantially ranges between 0.25 and 1,
ratio GD/ID substantially ranges between 0.65 and 0.9,
a3 substantially ranges between 50° and 70°, and
bowl diameter BD is smaller than upper inflection diameter ID2.

Thus, with this bowl parametrization, combustion of the fuel/oxidizer mixture for the maximum compression ratio occurs essentially in the torus volume, and combustion of the fuel/oxidizer mixture for the minimum compression ratio occurs essentially in the upper zone and above the piston, and preferably in the torus volume, as well as in the upper zone and above the piston.

1.-9. (canceled)

10. A variable-compression ratio direct-injection internal-combustion engine comprising at least one cylinder with each cylinder having a cylinder head carrying fuel injection spraying fuel in a sheet of fuel jets, a piston sliding in cylinder, and a combustion chamber delimited on one side by upper face of the piston comprising a projection rising upward towards the cylinder head and located in the center of a concave bowl, the combustion chamber comprising at least two mixing zones into which the fuel jets are injected, which one of the zones being used for obtaining a maximum compression ratio and another of zones being used for a minimum compression ratio.

11. An internal-combustion engine as claimed in claim 10, wherein the zones are associated together for achieving a minimum compression ratio.

12. An internal-combustion engine as claimed in claim 10, wherein mixing zones are axially arranged one above the other.

13. An internal-combustion engine as claimed in claim 11, wherein mixing zones are axially arranged one above the other.

14. An internal-combustion engine as claimed in claim 12, wherein the mixing zones are delimited from each other by a projection.

15. An internal-combustion engine as claimed in claim 13, wherein the mixing zones are delimited from each other by a projection.

16. An internal-combustion engine as claimed in claim 10, wherein one of the mixing zones comprises a concave surface connected to a convex surface which is a lower part of a toric volume.

17. An internal-combustion engine as claimed in claim 11, wherein one of the mixing zones comprises a concave surface connected to a convex surface which is a lower part of a toric volume.

18. An internal-combustion engine as claimed in claim 12, wherein one of the mixing zones comprises a concave surface connected to a convex surface which is a lower part of a toric volume.

19. An internal-combustion engine as claimed in claim 13, wherein one of the mixing zones comprises a concave surface connected to a convex surface which is a lower part of a toric volume.

20. An internal-combustion engine as claimed in claim 14, wherein one of the mixing zones comprises a concave surface connected to a convex surface which is a lower part of a toric volume.

21. An internal-combustion engine as claimed in claim 15, wherein one of the mixing zones comprises a concave surface connected to a convex surface which is a lower part of a toric volume

22. An internal-combustion engine as claimed in claim 10, wherein the another mixing zone comprises a concave surface connected to a convex surface forming a barrier.

23. An internal-combustion engine as claimed in claim 11, wherein the another mixing zone comprises a concave surface connected to a convex surface forming a barrier.

24. An internal-combustion engine as claimed in claim 12, wherein the another mixing zone comprises a concave surface connected to a convex surface forming a barrier.

25. An internal-combustion engine as claimed in claim 13, wherein the another mixing zone comprises a concave surface connected to a convex surface forming a barrier.

26. An internal-combustion engine as claimed in claim 14, wherein the another mixing zone comprises a concave surface connected to a convex surface forming a barrier.

27. An engine as claimed in claim 10, wherein the bowl has a bowl diameter BD, a neck diameter GD, a lower inflection diameter ID1, an upper inflection diameter ID2, a projection height H, a bowl height L, a height L1 of inflection diameter ID1, an angle of inclination a3, a radius R for concave rounded surface of torus and a radius R2 for concave rounded surface, wherein the bowl dimensions meet at least one:
ratio BD/L ranges between 1.3 and 1.8,
radio GD/BD ranges between 0.9 and 0.95 for the torus aerodynamics and the fuel jet upflow,
ratio H/L is less than 0.6 and greater than 0.5 to minimize oxidizer volume between an injector nozzle and the projection,
ratio L/L1 ranges between 1.15 and 1.7,
ratio R2/R ranges between 0.25 and 1,
ratio GD/ID ranges between 0.65 and 0.9,
a3 ranges between 50° and 70°, and
bowl diameter BD is smaller than diameter ID2.

28. A fuel injection method for a variable-compression ratio in direct-injection internal-combustion engine including at least one cylinder, each cylinder including a cylinder head carrying fuel injection spraying fuel in a sheet of fuel jets, a piston sliding in cylinder, and a combustion chamber delimited on one side by upper face of the piston comprising a projection rising upward towards the cylinder head and arranged in a concave bowl, comprising:
injecting fuel to provide a maximum compression ratio into a mixing zone of the combustion chamber; and injecting fuel to provide a minimum compression ratio into another mixing zone of the combustion chamber.

29. An injection method as claimed in claim 28, comprising injecting fuel for the minimum compression ratio into both mixing zones.
